(19) United States
(12) Patent Application Publication
(10) Pub. No.: US 2013/0201795 A1
(43) Pub. Date: Aug. 8, 2013

(54) FRACTURE IDENTIFICATION FROM AZIMUTHAL MIGRATED SEISMIC DATA

(71) Applicants: Changxi ZHOU, Katy, TX (US); Samik SIL, Houston, TX (US)

(72) Inventors: Changxi ZHOU, Katy, TX (US); Samik SIL, Houston, TX (US)

(73) Assignee: CONOCOPHILLIPS COMPANY, Houston, TX (US)

(21) Appl. No.: 13/656,001

(22) Filed: Oct. 19, 2012

Related U.S. Application Data
(60) Provisional application No. 61/577,963, filed on Dec. 20, 2011.

(51) Int. Cl. G01V 1/28

(52) U.S. Cl. CPC G01V 1/284
USPC 367/75

(57) ABSTRACT

A method is described for identifying anisotropic regions in unconventional hydrocarbon reservoirs, such as in shale formations. Anisotropy can be indicative of a zone of fracturing, which may represent a “sweet spot” for drilling a productive well. Seismic amplitude data from receivers is recorded along two orthogonal lines radiating from a seismic source. After time-migration, the equations for each orthogonal direction may be summed to obtain values for A and (Bᵢₛₒ+0.5*Bₐₙᵢ) which are independent of azimuth angle. Since Bᵢₛₒ is normally constant or slow varying over a shale formation, anisotropic regions may be identified by looking for anomalous values of (Bᵢₛₒ+0.5*Bₐₙᵢ).

### CROSS-REFERENCE TO RELATED APPLICATIONS

This application is a non-provisional application which claims benefit under 35 USC §119(e) to U.S. Provisional Application Ser. No. 61/577,963 filed Dec. 20, 2011, entitled “FRACTURE IDENTIFICATION FROM AZIMUTHAL MIGRATED SEISMIC DATA,” which is incorporated herein in its entirety.

### FIELD OF THE INVENTION

This invention relates to methods and systems for identification of fractured zones of subterranean hydrocarbon reservoirs, especially (but not limited to) unconventional reservoirs.

### BACKGROUND OF THE INVENTION

Unconventional hydrocarbon reservoirs are reservoirs that do not meet the criteria for conventional production, that is, oil and gas reservoirs which present a challenge for production because of their adverse porosity, permeability or other characteristics. Examples of unconventional reservoirs include coalbed methane, gas hydrates, shale gas, fractured reservoirs, and tight gas sands. Unconventional reservoirs such as tight gas sand reservoirs may be defined as sandstone formations with less than about 0.1 millidarcy permeability and low porosity.

It has been estimated that the total-gas-in-place in the United States may exceed 15,000 trillion cubic feet, the majority of which is contained in unconventional reservoirs. Needless to say, considerable research effort has been put into the development of techniques for exploitation of this challenging but abundant resource.

Production from unconventional reservoirs, e.g. tight gas sand or shale reservoirs, often depends on the presence of natural fractures in the reservoir. Fractured regions in an unconventional reservoir may be filled with readily extractable gas and may act as sweet spots for production purposes. Finding the sweet spots in unconventional reservoirs can be important for drilling wells that will be economically producible. Conversely, natural fractures can also represent hazards to drilling if they are water filled. The identification and characterization of naturally fractured zones in an unconventional reservoir can therefore be vital for successful and safe exploitation of the reservoir.

Identification of fractured zones is not only highly useful in exploration but can also be useful for infill drilling in an existing field, that is to say the drilling of additional wells between existing production wells to target bypass reservoirs.

One approach to finding naturally fractured zones or sweet spots is seismic analysis which attempts to identify seismically anisotropic regions within the reservoir. Anisotropy of a subterranean formation may be defined as the property of having different physical characteristics (e.g. seismic wave velocity) in different directions. A fractured region of a reservoir will generate seismic anisotropy since properties such as seismic wave velocities may be different along the direction of the fractures compared with the direction orthogonal to the fractures.

Current approaches use the so called AVAZ (amplitude versus azimuth angle) technique. This involves obtaining a large number of seismic data from many different azimuth angles (normally at least six azimuth directions). Azimuth is defined as the angle in a horizontal plane between the seismic source and the place where the reading is taken, relative to some datum angle (e.g. North). Normally, readings are also taken for different offsets (distance along the ground between source and reading) on each azimuth angle. This helps to increase the signal to noise ratio.

An analysis of this data is then undertaken, using an equation (see below) derived from Rüger's equation (Rüger, 1998). The equation relates p-wave reflectivity with incident (i) and azimuth (Φ) angle and three constants: A (intercept: seismic amplitude for zero offset), Bᵢₛₒ (gradient: related to the seismic amplitude changes in isotropic conditions) and Bₐₙᵢ (gradient: related to the seismic amplitude changes due to azimuth anisotropy). Φ₀ is the symmetry axis (perpendicular to the fracture direction, in case there is a single dominant fracture strike direction) of the medium.

Rₚ(i,Φ)=A+(Bᵢₛₒ+Bₐₙᵢ cos²(Φ−Φ₀))sin² i

For a given azimuth angle Φ, if this function is plotted with Rₚ on the y axis and sin² i on the x axis, a straight line graph is obtained having intercept A and gradient Bᵢₛₒ+Bₐₙᵢ cos²(Φ−Φ₀). This is shown in FIG. 1. This way of analyzing the data is known as amplitude versus offset (AVO); amplitude is essentially a measure of reflectivity; offset is the distance from the seismic source and is of course related to incident angle i.

The objective of AVAZ is to derive a reliable value for Bₐₙᵢ which is a function of fracture density. Values of Bₐₙᵢ may then be obtained for different locations and these can then be plotted as a graphic representation of the region, which can be for example a map, a cross section through the depth of the reservoir or a three dimensional image. Inspection of the image can reveal the presence of anomalies which may represent zones with a high degree of natural fracturing.

Rₚ(i, Φ), i and Φ are known, but A, Bᵢₛₒ, Bₐₙᵢ, and Φ₀ are all unknowns. Having taken readings at many azimuth angles, the difference between maximum and minimum amplitude values for a certain incident angle i should in theory provide a value for Bₐₙᵢ since A and Bᵢₛₒ should in theory not be affected by azimuth angle, or at least be much less influenced by azimuth angle than Bₐₙᵢ. A graphic representation of this technique is shown in FIG. 2.

The technique works satisfactorily for predicting fracture zones where the fractures lie in one predominant direction (so called single strike direction). However, when there are multiple fractures with different strike directions, the amplitude or gradient fitting method based on the above equation may return a wrong estimation of the fracture property. FIG. 2 shows amplitude responses of a multiple fractured medium (two fracture sets, one along 0 degree and another along 75 degree azimuth) for different incident angles. Here it is still possible to fit the equation and derive an estimate of one fracture direction which is not the true fracture strike direction of any of the fracture sets in the medium. The incorrect estimation of fracture direction (or Φ₀) will lead to a wrong estimate of Bₐₙᵢ and to a wrong interpretation of fracture sweet spots. A recent study also shows AVAZ analysis for a medium with a single fracture direction (i.e. a pure HTI medium) alone cannot resolve the true fracture property (as it cannot resolve the value of Φ₀ uniquely) if it is not tied with the travel time analysis or with prior modeling (Goodway et al, 2010).

In addition to the above shortcomings, the AVAZ technique requires a considerable amount of data to be gathered, which is both costly and time consuming. In marine environments, gathering of readings on many azimuth angles is almost impossible as a practical matter.

There is therefore a need for a technique which may be robust enough to identify fractured regions which have one or more than one strike direction, and/or requires fewer readings in the azimuth direction and/or is applicable to a marine environment.

### BRIEF SUMMARY OF THE DISCLOSURE

In one embodiment, the invention comprises a method of identifying a fractured zone in a subterranean reservoir. A fractured zone could be defined as a zone which naturally has a substantially higher density of fractures than other parts of the reservoir (e.g. at least 10% more fractures per unit volume, or at least 20% or 30% more). The method may comprise:
(a) recording or obtaining raw seismic data along two substantially orthogonal azimuth directions from a seismic source;
(b) performing a time migration conditioning or imaging step on said raw data;
(c) summing said orthogonal time migrated data; and
(d) from said summed time migrated data, deriving value(s) indicative of anisotropy.

Summing the orthogonal azimuth sector data may eliminate the dependence of azimuth angle from the result, which means that the result may be substantially independent of azimuth angle and therefore the technique may identify fractured zones which have one, two or more strike directions. By “substantially independent of azimuth angle” is meant, if data is recorded along any different pair of orthogonal azimuth directions from the same source, the derived value(s) will vary by less than 20%, optionally less than 10%, optionally less than 5% with azimuth.

The method may make use of the equation (or its mathematical equivalent):

½[Rₚ(i,Φ)+Rₚ(i,Φ+π/2)]=A+(Bᵢₛₒ+0.5*Bₐₙᵢ)sin² i

where i, Φ, Rₚ, A, Bᵢₛₒ and Bₐₙᵢ are as defined above.

Amplitude versus offset (AVO) analysis may be applied to determine Bᵢₛₒ+0.5*Bₐₙᵢ from said equation, Bᵢₛₒ+0.5*Bₐₙᵢ being indicative of anisotropy when the isotropic property Bᵢₛₒ is substantially constant or slow varying over the reservoir.

The method may involve a checking step whereby if said summed data shows azimuthal variation of amplitude, further analysis or processing of the data may be carried out.

The method may involve a further checking step whereby data from each of said two substantially orthogonal directions is subtracted and the result checked for a zero or near zero intercept (A) value. If more than two azimuth sectors of data are available, then an even more robust check is possible.

Seismic survey equipment may be set up specifically for this analysis. Each seismic source (an impulse imparted to the ground by a small explosion or by some other means) would be associated with a number of seismic receivers, e.g. 10 or more, accurately arranged along two lines radiating from the source and at exactly 90 degrees (azimuth) to each other. An area to be surveyed would be covered by a large number of such arrangements of apparatus, the number obviously depending on the size of the area to be covered.

In practice, there may be reasons why the receivers cannot be placed along exact lines, such as the presence of housing or other structures or because of access difficulties. A certain amount of deviation from the ideal will be possible whilst still achieving a useful result, and the term “substantially orthogonal” as used above may be interpreted accordingly to mean “sufficiently orthogonal to produce a meaningful result”. Deviation may be in two senses: (i) receivers not lying on a straight line and/or (ii) a best fit line through one set of receivers not being at exactly 90 degrees to a best fit line through the other (“orthogonal”) set of receivers.

Conventionally, seismic surveys tend to be carried out on a Cartesian grid. This fits well with the method of the invention since only two orthogonal lines of received data are needed, but of course it does not fit well with the AVAZ technique which would require the use of data from receivers not lying on lines radiating from the source; the data in this case would need to be “binned” into angular ranges approximating the desired direction.

The concept of the “binning” of data within defined sectors emanating from the source may be a useful one for the present invention, too, when receivers are not in their ideal positions. For example, a sector “bin” having an angle range as much as 30 degrees (i.e. 15 degrees each side of the a desired direction) would be normal in seismic data collection and would probably be tolerated by the technique of the invention. However, this has not yet been investigated fully by the inventors. It may be that a smaller angle range would be necessary, e.g. up to 20 degrees or up to 10 degrees or even up to 5 degrees. It is also possible that the technique would tolerate larger angle ranges such as up to 40, 50, 60 or even, in the limit, 90 degrees.

In the extreme case of the bin sector angle being 90 degrees, data is being received in total over a 180 degree arc, with no angle in that 180 degree arc not being covered.

If data is collected or binned over large angle sectors, it is worth considering how to define the orthogonal lines. These could just be defined as the bisecting lines of the sectors over which the respective sets of data are collected or binned. Alternatively, a notional “best fit” line could be drawn through the receiver positions. In the latter case, it is possible that the two best fit lines would not be at exactly 90 degrees to each other. Again, this has not been fully investigated, but it is envisaged that some deviation from 90 degrees could be tolerated, for example the lines could be in the range of 60 to 120 degrees from each other or 75 to 105 degrees, 80 to 100 or 85 to 95 degrees.

It will be appreciated that the technique according to the invention could be used to re-analyze data which had previously been collected and analyzed by conventional techniques. In this case, the above discussion about what data points to include or exclude from the analysis is obviously very relevant. The step of obtaining the data would, in this case, refer to a process of retrieving data from previous seismic surveys. This data may need to be binned into sectors as discussed above.

It should be understood that “raw” seismic data referred to above is amplitude data which has been subject to processing to compensate for geometric spreading and attenuation so that amplitude data received at different distances from the source is comparable.

### BRIEF DESCRIPTION OF THE DRAWINGS

FIG. 1 is a graph showing how p wave reflectivity varies with sin square of incident angle for a given azimuth angle (prior art);

FIG. 2 is a plot of recorded wave amplitude (a measure of reflectivity) against azimuth angle for a given incident angle (offset) in a region with two fracture strike directions which differ by 75° (prior art);

FIG. 3 is a plan showing the position of seismic receivers in relation to a seismic source;

FIG. 4 is a series of plots of angle gathers from a model based on log data from a reservoir, as described in Example 1;

FIG. 5 is an A/B cross plot based on the angle gathers of FIG. 4 over a small depth window as described in Example 1;

FIG. 6 is an A/B cross plot based on the angle gathers of FIG. 4 at a constant depth as described in Example 1;

FIG. 7 is a series of plots of angle gathers from two models based on log data from two wells in the Eagle Ford shale formation, as described in Example 2;

FIG. 8 is an A/B cross plot based on the angle gathers of FIG. 7, for the top of the Eagle Ford interval, as described in Example 2; and

FIG. 9 is an A/B cross plot based on the angle gathers of FIG. 7, for the base of the Eagle Ford interval, as described in Example 2.

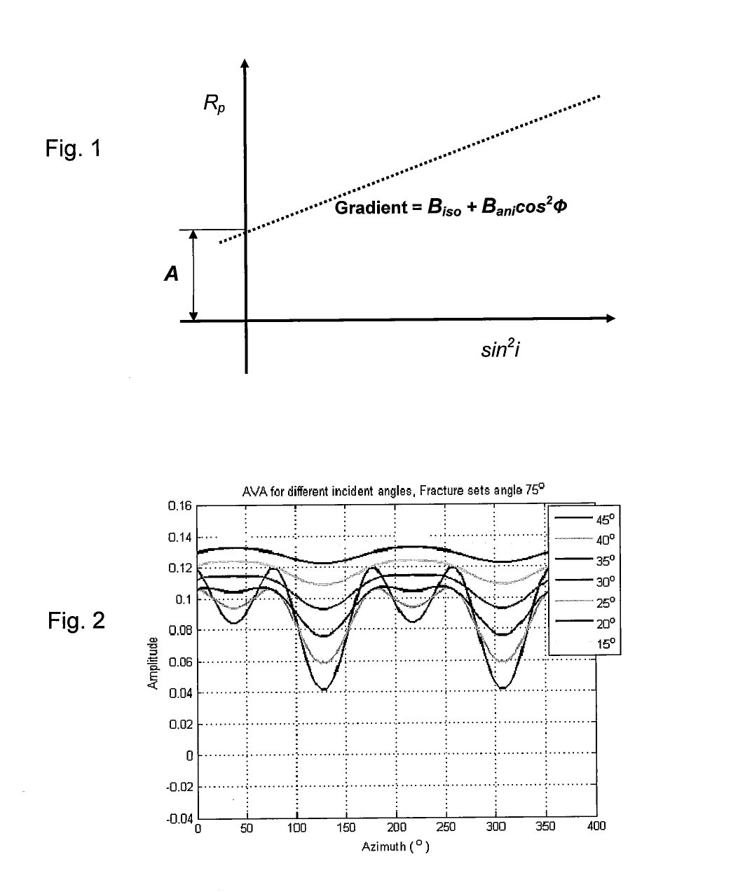

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

Unidirectional regional stress and/or the presence of unidirectional vertical fractures make a medium transversely isotropic, with a horizontal axis of symmetry (HTI) with respect to seismic wave propagation. Seismic P-wave reflectivity in an HTI medium can be approximated by Rüger's equation (Rüger, 1998):

$${R}_{P} ( i , φ ) = \frac{1}{2} \frac{Δ Z}{\overline{Z}} + \frac{1}{2} \{ \begin{matrix}\frac{Δα}{\overline{α}} - {( \frac{2 \overline{β}}{\overline{α}} )}^{2} \frac{Δ G}{\overline{G}} + \\ [ Δ {δ}^{( V )} + 2 {( \frac{2 \overline{β}}{\overline{α}} )}^{2} Δ γ ] {cos}^{2} φ\end{matrix} \} {sin}^{2} i + \frac{1}{2} \{ \frac{Δα}{\overline{α}} + {Δε}^{( V )} {cos}^{4} φ + {Δδ}^{( V )} {sin}^{2} {φcos}^{2} φ \} \times {sin}^{2} i {tan}^{2} i , \qquad ( 1 )$$

where i is the incident angle, Φ is the azimuth angle, Z is seismic impedance, Rüger is S-wave velocity, Δ is P-wave velocity, γ, δ and ε are the Thompsen's anisotropy parameters, G is shear modulus, (V) indicates the Thompsen's parameter for a HTI medium. If we keep the second order approximation of this equation, we can write:

Rₚ(i,Φ)=A+(Bᵢₛₒ+Bₐₙᵢ cos²(Φ−Φ₀))sin² i (I)

This equation (or its mathematical equivalent) is the basis for the AVAZ method as discussed above. However, also as discussed above, the AVAZ method tends to give inaccurate results if there are fractures in more than one direction or, say, outside a relatively narrow range of angles, e.g. 30°. The inventors have devised a method which is independent of the azimuth direction and therefore independent of the direction of the seismic anisotropy due to fractures. The method is therefore suitable for a situation where there are fractures in a range of different directions, but is also suitable for when the fractures are all in substantially the same direction.

Re-writing equation I in terms of Φ+π/2, we get:

Rₚ(i,Φ+π/2)=A+(Bᵢₛₒ+Bₐₙᵢ cos²(Φ−Φ₀+π/2))sin² i (Ia)

In general, cos² a+cos²(a+π/2)=1 for any angle α. Therefore, if the two equations I and Ia are added, one gets:

½[Rₚ(i,Φ)+Rₚ(i,Φ+π/2)]=A+(Bᵢₛₒ+0.5*Bₐₙᵢ)sin² i. (II)

Equation II shows that reflectivity of the summed data from any two orthogonal directions is not a function of azimuth, because the added terms in Φ cancel out. Therefore, conducting a seismic test along any two orthogonal directions and then summing the data and plotting reflectivity (amplitude) against sin² i should give a straight line having intercept A and gradient (Bᵢₛₒ+0.5*Bₐₙᵢ), irrespective of the azimuth directions chosen for the test. Repeating the test at the same site for a different orthogonal pair of directions should give the same result, since the result should be independent of azimuth angle.

When a number of seismic tests of this type are conducted at different locations over an hydrocarbon field, or over part of an hydrocarbon field, the Bᵢₛₒ parameter can be expected to be essentially constant for many unconventional reservoirs. The Bₐₙᵢ parameter can of course be expected to vary according to whether there is anisotropy due to fracturing and so can the summed parameter (Bᵢₛₒ+0.5*Bₐₙᵢ). The combined parameter can therefore be mapped to show up fractured regions of the mapped area. It can also be possible to isolate Bₐₙᵢ (see below).

As a check, summed data for different azimuth values Φ (i.e. different summed sets of readings along different pairs of orthogonal azimuth directions), can be examined to ensure that the results do not vary unduly, which gives an indication of the data quality.

A further check would be to subtract two different azimuth sector data sets and determine whether the value for A is zero or near zero, which also gives a measure of data quality.

If either of these checks does not produce the expected result, then this would indicate a need to check the data or the data processing.

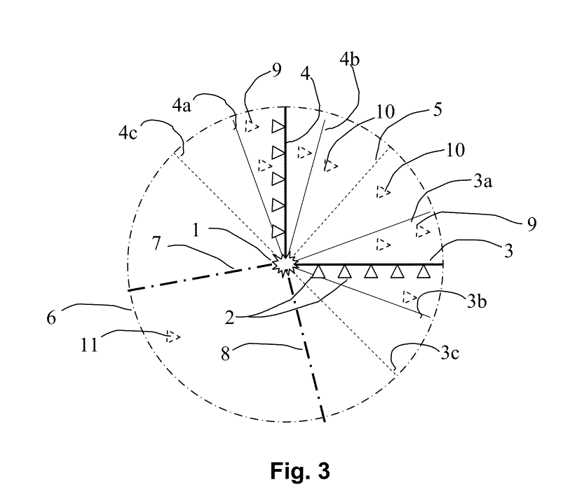

FIG. 3 shows a seismic source 1, with seismic receivers 2 placed at intervals along two orthogonal lines 3, 4 which we can call the x and y lines respectively. This is an ideal arrangement of receivers and source. Only 5 receivers are shown along each of the x and y lines, but there would normally be more than this. This arrangement basically covers a circular area 6. Any pair of orthogonal lines of the same length radiating from the source 1 should in theory give the same result. Two alternative orthogonal lines 7, 8 are shown as dot-dash lines in FIG. 3.

A number of sets of sources and receivers will be arranged to cover a desired survey area. It will be understood that, if the sources and receivers are set out in a Cartesian grid, then many of the receivers may be used to receive data originating from more than one of the seismic sources.

FIG. 3 also shows in dashed lines a few receivers 9 which do not lie on the x and y axes 3, 4. This could be for a number of reasons, e.g. because of buildings being in the way or access difficulties. The mis-placed receivers lie in a sector bounded by lines 3a and 3b on each side of the x line and in a sector bounded by the lines 4a and 4b on each side of the y line. A decision can be made how large a sector angle can be tolerated before the results of the survey become too inaccurate to use, and data from any receivers which are placed outside these sectors would not be used. Two such receivers 10 are indicated in FIG. 3. Alternatively, it may be that acceptable results could be obtained by using data from receivers anywhere in a 180 degree sector bounded by the lines 3c and 4c in FIG. 3. In this case, data from receivers in the 90 degree sector between lines 3c and 5 would be assigned, or binned, to the x line and data from receivers in the sector between lines 4c and 5 would be binned to the y line. Only data from receivers 11 outside the 180 degree sector would be ignored.

Its is unlikely that receivers would be placed as far from the desired locations as the receivers marked 10 or 11 in FIG. 3. However, the technique according to the invention can also be used with survey data which has not been gathered with this analysis technique specifically in mind. In this case, a process of determining which receiver data to use and which to ignore, and which direction or x, y line to assign data to, can be carried out prior to performing the analysis for determining anisotropy.

The practical steps for obtaining Bₐₙᵢ can be set out as follows:

### 1. Flatten the Data in Each Azimuth Sector.

Data will be received from seismic sensors as amplitude readings, that is to say readings of the strength of the received signals. This data will be subject to processing to compensate for the effects of geometric spreading and attenuation, as is conventional in this technical field.

Each received signal will have been reflected from an interface (horizon) between two subsurface strata which acts as a reflector of seismic signals. There may be a number of reflectors which give rise to signals. The time at which the signal is received is therefore also recorded and this, together with knowledge of the velocity of seismic waves in the medium, allows signals corresponding to reflections from a given horizon to be grouped together. This process is known as time migration or flattening of the raw data. The result is a simple series of amplitude values for a given azimuth angle, one value for each source-receiver pair, all of which represent the amplitude of a signal reflected from the horizon under consideration (normally the horizon of a subterranean reservoir).

### 2. Sum Two Perpendicular Sector Seismic Data.

The two sets of time-migrated, or flattened, data are then simply summed.

According to equation II above, the summed data should, depending on the quality of the data and data processing, be independent or largely independent of azimuth angle. This can be checked by taking data along a different orthogonal pair of azimuth directions from the same source, and processing the data in the same way to see how similar it is to the original summed, time-migrated data.

### 3. Subtract the Two Different Azimuth Sector Seismic Data.

This step is a further check on the quality of the data and/or data processing. A (the intercept value from AVO analysis) should, according to equation I, be the same for any azimuth direction. Subtracting the data should, depending on the quality of the data and/or data processing, give rise to a zero or substantially zero value for A if the two data sets are subtracted from each other.

### 4. Perform Regular AVO on Summed Data.

Amplitude versus offset analysis, which is well known in this field of technology, is then applied to get values for the intercept (A) and the gradient (Bᵢₛₒ+0.5*Bₐₙᵢ). If it is assumed that Bᵢₛₒ is almost constant or is a slow varying function on the reservoir horizon, then it is possible to cross-plot A/B to identify the AVO gradient anomaly due to the addition of Bₐₙᵢ.

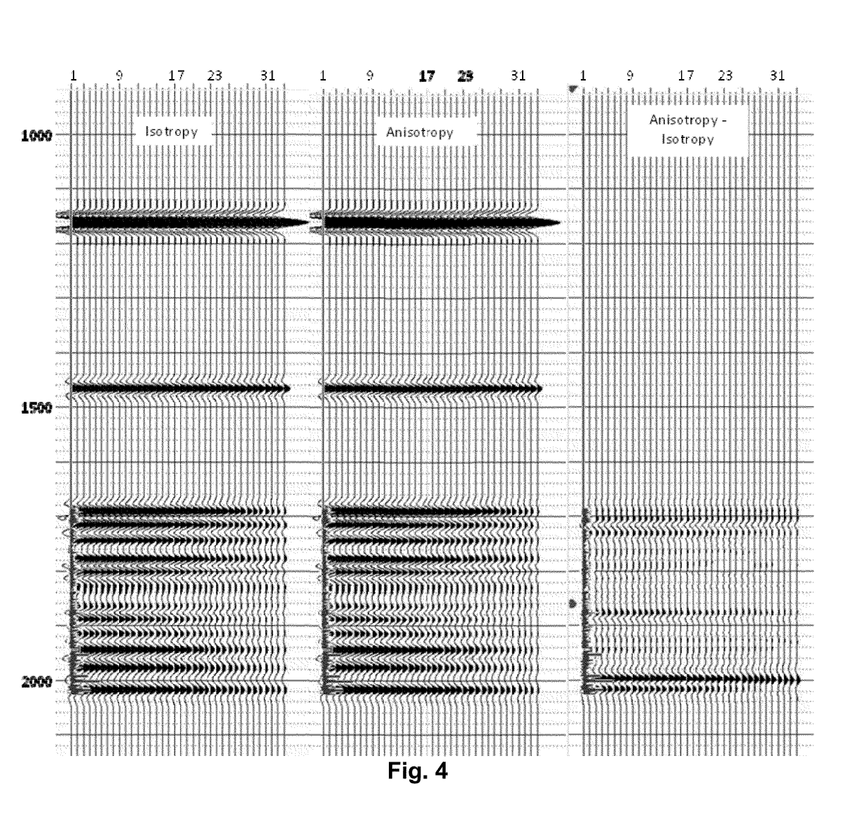

To show the feasibility of the method of detecting fractures, two synthetic tests were performed. The first synthetic example is shown in FIGS. 4, 5 and 6.

### Example 1

The first synthetic model was constructed using measured log data from a well in Uinta Basin, North-East Echo Spring, Wyo., USA. Since the model is constructed based on real data, it provides a good test for whether the technique of the invention will work well in a real life situation.

In this case, the reservoir interval was between 11300 ft to 11700 ft, which showed weak anisotropy. The anisotropy parameters were calculated from measured fast and slow S-wave velocities using a known technique (Sil et al., 2010). Both anisotropy and isotropy cases were modeled for many locations. Most of these locations were modeled using the same isotropic properties. A smaller number of locations were modeled using anisotropic properties.

FIG. 4 shows modeled “angle gathers”, that is to say data plotted with respect to incident angle i. The angle gathers were produced using a reflectivity code—a data processing algorithm which will be familiar to those operating in this technical field. Time migrated data (flattened data) is shown. On the Y axis is time, which corresponds to depth, and on the X axis is receiver location, in terms of incident angle. Each horizontal black bar represents signals received from one reflector.

The left angle gather (the plot on the far left of the three plots shown in FIG. 4) shows data from an isotropic version of the model, i.e. with the anisotropy parameters (Gamma, Epsilon and Delta) set to zero. The middle angle gather plot in FIG. 4 is based on the model with in situ anisotropy, as derived from the log data. The right angle gather plot is the difference between the anisotropic and isotropic angle gathers. It shows a large seismic amplitude difference at the bottom of the reservoir, indicating the presence of a relatively large degree of anisotropy in that interval. Therefore, this interval was targeted for AVO analysis to demonstrate the technique of the invention.

AVO analysis was performed on the synthetic data for a number of locations of the seismic source. For each location, several AVO analyses were taken from different depths within the small chosen reservoir interval from 2000 ms to 2020 ms, which is the interval for which a large degree of anisotropy is indicated by the log data (see FIG. 4). In each case, the technique according to the invention was applied: time migrated data from receivers in one direction were added to time migrated data from receivers in an orthogonal direction and a value derived for A (the intercept) and B (the gradient), where B represented the sum of Bᵢₛₒ and Bₐₙᵢ

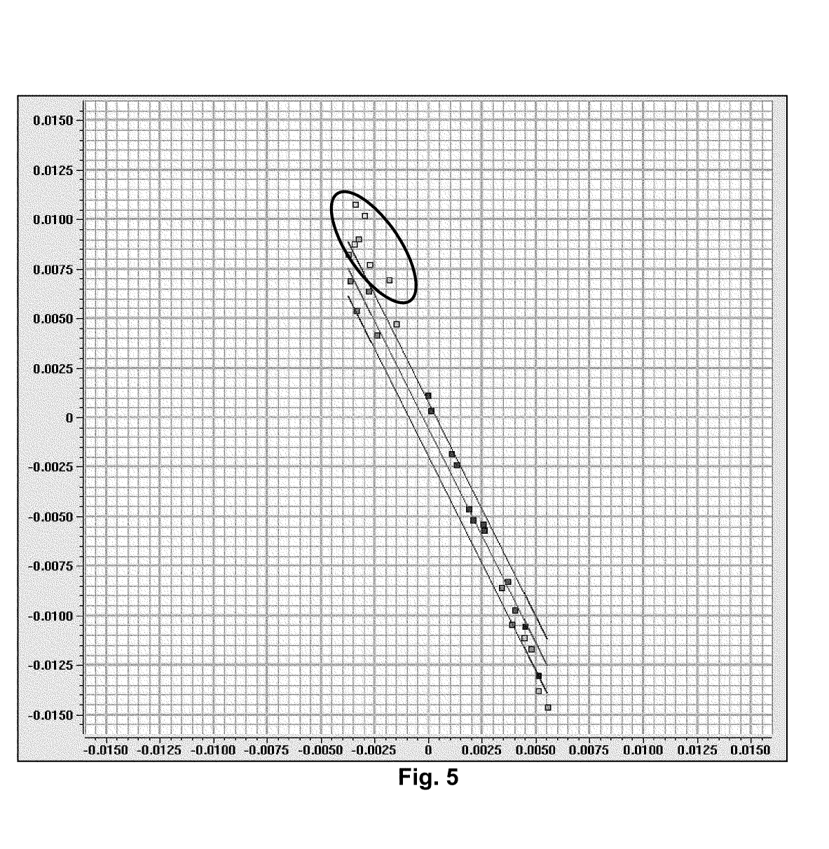

FIG. 5 shows the results of the AVO analysis, in particular a cross plot of the gradient B vs. the intercept A. Each point on the plot is shaded according to depth. The location represented by each point is known and can be projected back into a seismic image which represents anisotropic locations in space—for example a plan or section or a 3d image.

Looking at FIG. 5, data points having the same shading tend to be grouped together, A and B are approximately constant over the field unless there is anisotropy, which shows up where the dots no longer lie on or near a straight line on the cross plot. Data points representing anisotropy are apparent at anisotropy locations which were modeled (points indicated with an ellipse).

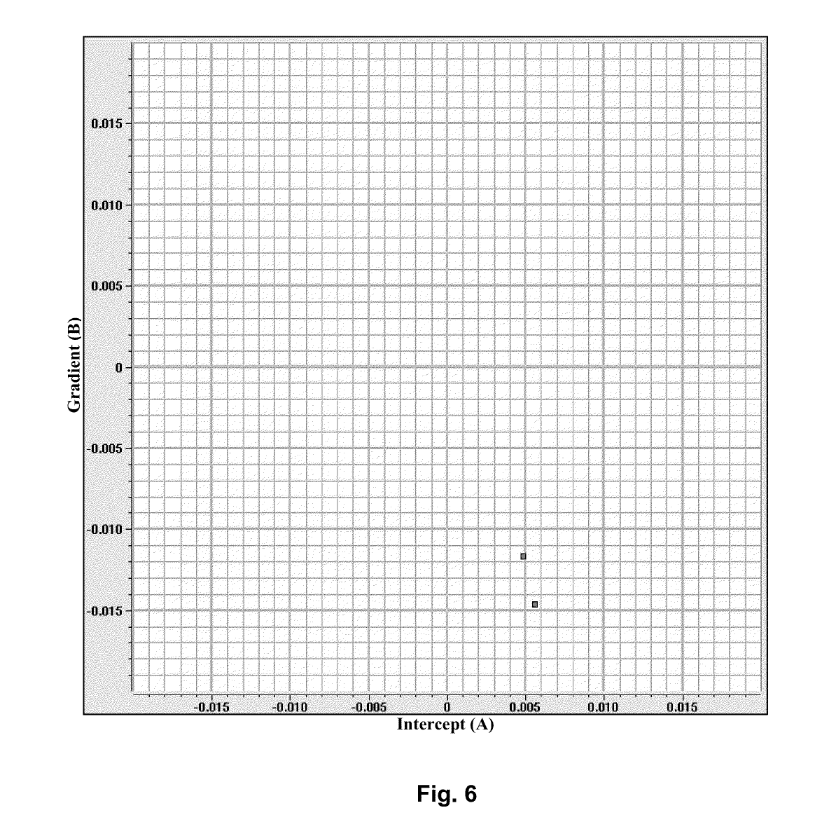

FIG. 6 is an A/B cross-plot of AVO data from an analysis according to the invention, at the reservoir base (at 2020 ms). Two points are shown: one based on the isotropic version of the model and one on the model including anisotropic data. As can be seen in the Figure, the two points are clearly separated showing that the analysis has distinguished between the purely isotropic case and the anisotropic even for relatively weak anisotropy. It can be seen that the intercept value A for the isotropic and anisotropic cases are almost the same. However, the gradient value B for the anisotropic case is about 25% larger than for the isotropic case because of the contribution of Bₐₙᵢ, even though the anisotropy is weak. This result indicates that AVO A/B cross-plot may be adequate for indentifying the presence of fractures.

### Example 2

To consider the impact of varying reservoir properties, a synthetic data set was constructed from two wells from Eagle Ford, a shale formation in South Texas, USA. The wells are 5 miles apart. The difference in average Poisson's ratio of the Eagle Ford interval in these two wells is more than 15%.

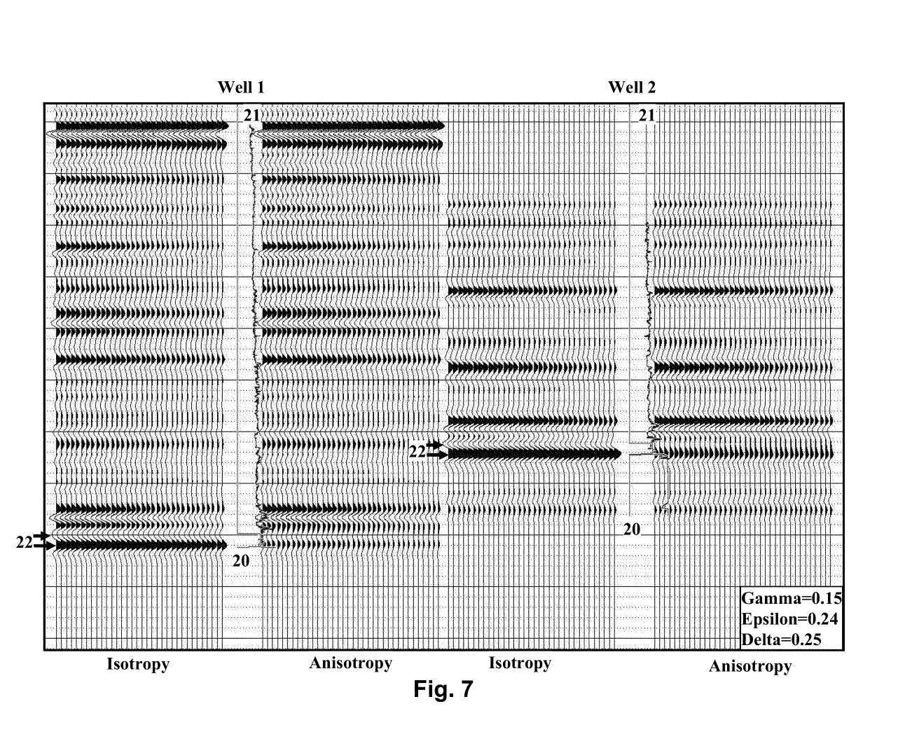

In a method similar to Example 1, isotropic and anisotropic cases were modeled for both wells. The calculated angle gathers are shown in FIG. 7. The inserted light gray traces 20 (between the isotropic and the anisotropic synthetics for each well) are the S-wave splitting factor. The darker inserted traces 21 are the measured sonic logs. The gray arrows 22 indicate the reservoir top and base. The reservoir interval in well 1 is deeper than in well 2. Compared to the isotropic case, the anisotropy has larger impact on the reflection amplitudes from the reservoir top and base. Overall, anisotropy makes the reservoir top and base reflections dimmer.

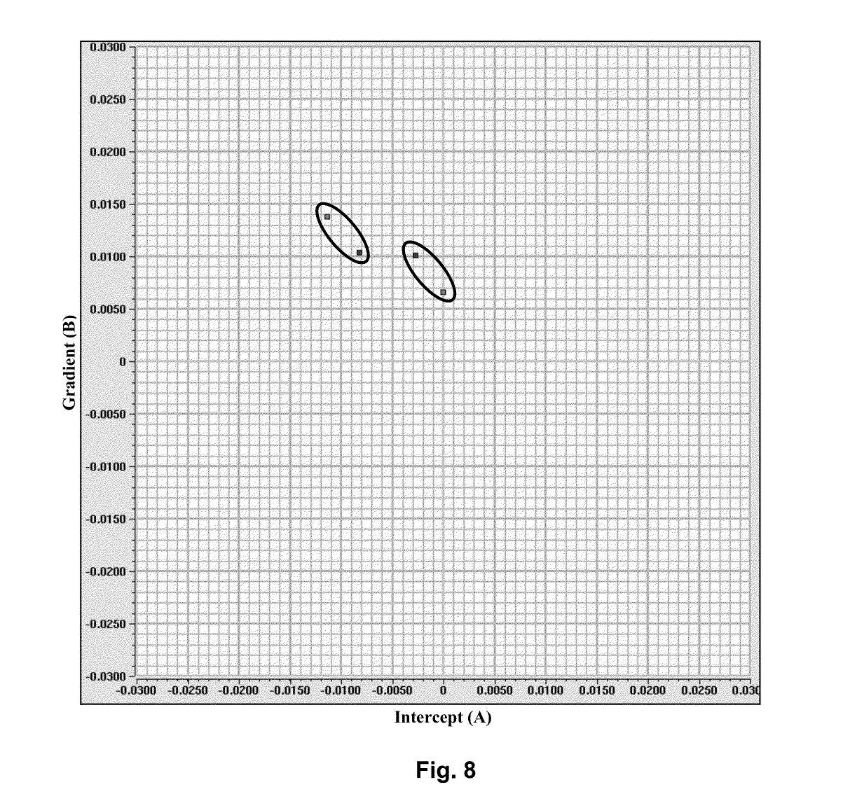

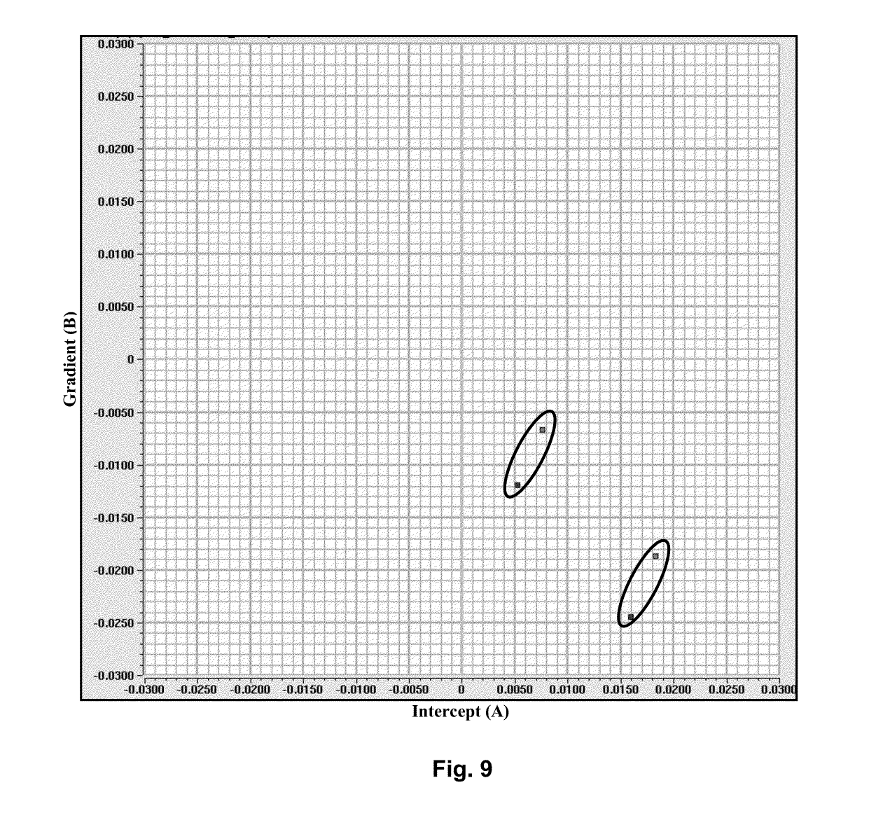

The AVO intercept A and gradient B were calculated from the angle gathers shown in FIG. 7 and A/B cross-plot analysis performed (shown in FIGS. 8 and 9). The A/B cross-plot at the Eagle Ford top is shown in FIG. 8 and the A/B cross-plot at the base is shown in FIG. 9. As with Example 1, it can be seen from the plots that points corresponding to locations with anisotropy are separated from points corresponding to purely isotropic locations in the A/B cross-plot domain.

This synthetic test indicates that in a shale formation with slow varying reservoir properties, the AVO cross-plot from the azimuth migrated data can be used to identify anisotropic anomalies and thus identify the presence of vertical fractures.

### REFERENCES

All of the references cited herein are expressly incorporated by reference. The discussion of any reference is not an admission that it is prior art to the present invention, especially any reference that may have a publication data after the priority date of this application. Incorporated references are listed again here for convenience:
1. Rüger, “Variation of P-wave reflectivity with offset and azimuth in anisotropic media”, Geophysics, Vol. 63, No. 3, 1998, pp 935-947.
2. Goodway et al., “Seismic petrophysics and isotropic-anisotropic AVO methods for unconventional gas exploration”, The Leading Edge, December 2010, pp. 1500-1508
3. Sil et al, “Effect of near-surface anisotropy on a deep anisotropic target layer”, SEG San Antonio 2011 meeting

1. A method of identifying one or more fractured zones in a subterranean reservoir, the method comprising:
a) recording or obtaining raw seismic data along two substantially orthogonal azimuth directions from a seismic source;
b) performing a time migration conditioning step on said raw data;
c) summing said time-migrated data; and
d) from said summed time-migrated data, deriving values indicative of anisotropy, thereby identifying said fractured zone or zones.

2. The method of claim 1, wherein said values are substantially independent of azimuth angle.

3. The method of claim 1 wherein said identified fractured zone or zones has two or more fracture strike directions.

4. The method of claim 3 wherein the said fracture strike directions differ by more than 30 degrees, optionally more than 45 degrees, optionally more than 60 degrees.

5. The method of claim 1 wherein the following equation, or its mathematical equivalent, is applied:
½[Rₚ(i,Φ)+Rₚ(i,Φ+π/2)]=A+(Bᵢₛₒ+0.5*Bₐₙᵢ sin² i),
where i represents incident angle, Φ azimuth angle, Rₚ reflectivity, A seismic amplitude for zero offset, Bᵢₛₒ a gradient value related to the seismic amplitude changes in isotropic conditions, and Bₐₙᵢ a gradient value related to the seismic amplitude changes due to azimuth anisotropy.

6. The method of claim 5 further comprising applying amplitude versus offset (AVO) analysis to determine values for (Bᵢₛₒ+0.5*Bₐₙᵢ), being said values indicative of anisotropy.

7. The method of claim 1, comprising a checking step wherein a second set of summed time-migrated data is derived from raw data from a further pair of substantially orthogonal azimuth directions from said seismic source, then said summed time-migrated data and said second set of summed time-migrated data analyzed for azimuthal variation of amplitude.

8. The method of claim 5, comprising an alternative checking step whereby time-migrated data from each of said two substantially orthogonal directions is subtracted and the result analyzed to determine how close to zero is the value for A which is derived from the subtracted data.

9. The method of claim 5, further comprising creating a cross plot of values of A and (Bᵢₛₒ+0.5*Bₐₙᵢ) to highlight said values indicative of anisotropy.

10. The method of claim 1 wherein step (a) involves binning data in each of two sectors radiating from said seismic source, said sectors being bisected respectively by said two substantially orthogonal lines.

11. The method of claim 10 wherein the angles of said sectors at said seismic source are less than 10 degrees, optionally less than 20, 30, 45, 60 or 90 degrees.

12. The method of claim 1 wherein steps b), c) and d) are performed only on data obtained or recorded along two substantially orthogonal azimuth directions.

13. A method of identifying one or more fractured zones in a subterranean reservoir, the method comprising:
a) recording or obtaining first and second sets of raw seismic data respectively along first and second substantially orthogonal azimuth directions from a seismic source;
b) performing a time migration conditioning step on said first and second sets of raw data to obtain respective first and second sets of time-migrated data;
c) summing only said first and second sets of time-migrated data to produce a set of summed time-migrated data; and
d) using only said set of summed time-migrated data to derive values indicative of anisotropy, thereby identifying said fractured zone or zones.
